(19) United States
(12) Patent Application Publication
(10) Pub. No.: US 2008/0205500 A1
(43) Pub. Date: Aug. 28, 2008

(54) RADIOFREQUENCY TEST SYSTEM INTEGRATED IN A BASE STATION

(76) Inventors: Danny C-Liu, Belle Mead, NJ (US); Henry D. Moher, Colonia, NJ (US); Igor Murkis, Mercerville, NJ (US); Mark S. Paradiso, North Haledon, NJ (US)

Correspondence Address: MARK W. SINCELL;Williams, Morgan & Amerson, P.C., Suite 1100, 10333 Richmond, Houston, TX, 77042, US

(21) Appl. No.: 11/678,359

(22) Filed: Feb. 23, 2007

(51) Int. Cl. H04B 3/46

(52) U.S. Cl. 375/224; 375/E01.001

(57) ABSTRACT

The present invention provides a method of performing tests of at least one base station. The method includes accessing, using digital processing circuitry coupled to at least one base station, a portion of a radio frequency signal. The method also includes performing, using the digital processing circuitry, at least one measurement based upon the radiofrequency signal and providing information indicative of the measurements to a processing device at a location remote from the base station while the digital processing circuitry remains coupled to the base station(s).

### BACKGROUND OF THE INVENTION

1. Field of the Invention

This invention relates generally to communication systems, and, more particularly, to wireless communication systems.

2. Description of the Related Art

A conventional wireless communication system typically includes numerous base stations for providing wireless connectivity to mobile units located within a geographic area, or cell, associated with each base station. Electromagnetic waves in the radiofrequency band are typically used to carry information between base stations and mobile units. For example, a base station may generate a baseband signal at a selected frequency in the radio band and may then modulate the baseband signal to reflect information to be transmitted to a mobile unit. The modulated radiofrequency waves may then be transmitted through the air to the mobile unit, which may decode the received waves to extract the transmitted information. Similarly, mobile units may also generate modulated radiofrequency waves that may be used to convey information to one or more base stations. The wireless communication link from the base station to the mobile unit is typically referred to as the downlink (or the forward link) and the wireless communication link from the mobile unit to the base station is typically referred to as the uplink (or the reverse link).

The performance of a wireless communication system may be affected by environmental conditions. For example, interference from other sources of electromagnetic radiation may disrupt transmissions between a base station and the mobile units located in the cell served by the base station. Examples of interference sources include other radiofrequency transmitters, such as mobile units operating the serving cell or other nearby cells. Interference from mobile units in adjacent cells is typically referred to as inter-cellular interference. Non-compliant electronic devices that broadcast in frequency bands allocated to wireless communication and defective broadcasting devices may also cause interference. The uplink is particularly vulnerable to disruption by interference because mobile units typically transmit at very low powers relative to other sources of radiofrequency noise or interference. Increasing the base station sensitivity to frequency bands used for the uplink also increases the susceptibility of the base station to interference in the same frequency band.

The performance of the base station may also change over time, potentially leading to conditions that may degrade overall performance of the wireless communication system. For example, the transmission power of each base station in a coverage area is carefully controlled so that the cell coverage provided by each base station completely covers its associated coverage area with a relatively small overlap with adjacent coverage areas. The wireless communication system relies upon accurate calibrations of the transmitted power to predict the cell coverage provided by the base stations and to detect problems that may affect system performance. For example, the transmission power may fluctuate, leading to a fluctuation in the cell coverage area and/or capacity. The wireless communication system requires an accurate calibration of the transmitted power to determine whether or not the transmission power fluctuations are within an acceptable level. However, the calibration of the base station transmission power may become less accurate over time, which may limit the ability of the wireless communication system to detect performance problems such as excessive transmission power fluctuations.

Diagnostic tests may be performed using portable testing devices to assess the performance of base stations. For example, base stations typically include one or more ports for attaching portable testing devices and allowing the testing device to tap into the uplink and/or downlink transmissions. An engineer may carry a portable testing device to a base station site, attach the device to the available ports, and then perform one or more diagnostic tests to assess the performance of the base station. However, base stations are often located in remote, inaccessible, and/or inhospitable sites. For example, base stations may be located along freeways far from any towns, at the top of telephone poles or transmission towers, in mountainous or intemperate areas, and the like. Transporting testing devices to these base stations is costly, time-consuming, labor-intensive, and potentially risky for the engineer. Furthermore, transporting an individual testing device to each base station makes it difficult to coordinate or synchronize measurements performed by testing devices at different base stations.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for performing tests of at least one base station. The method includes accessing, using digital processing circuitry coupled to at least one base station, a portion of a radio frequency signal. The method also includes performing, using the digital processing circuitry, at least one measurement based upon the radiofrequency signal and providing information indicative of the measurements to a processing device at a location remote from the base station while the digital processing circuitry remains coupled to the base station(s).

In another embodiment of the present invention, a method is provided for performing tests of at least one base station. The method includes receiving, at a processing device deployed remote from at least one base station, information indicative of at least one measurement performed using digital processing circuitry coupled to the base station(s). The measurement(s) are performed on a portion of a radiofrequency signal and the information is received while the digital processing circuitry remains coupled to the base station(s).

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a wireless communication system, in accordance with the present invention;

FIG. 2 conceptually illustrates one exemplary embodiment of an integrated test system, in accordance with the present invention; and

FIG. 3 conceptually illustrates a second exemplary embodiment of a wireless communication system, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

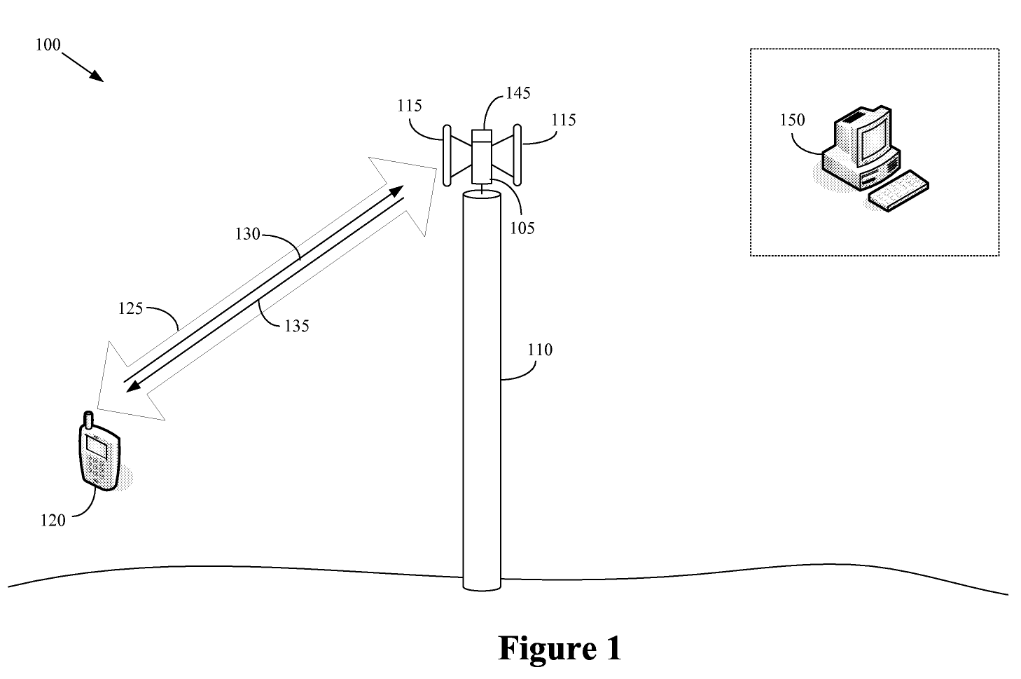

FIG. 1 conceptually illustrates a first exemplary embodiment of a wireless communication system 100. In the illustrated embodiment, the wireless communication system 100 includes a base station 105 that is deployed on top of a tower 110. However, persons of ordinary skill in the art having benefit of the present disclosure should appreciate that the present invention is not limited to base stations 105 deployed on towers 110. In alternative embodiments, the base station 105 may be deployed at any location including, but not limited to, telephone poles, buildings, trees, and the like. Furthermore, the term “base station” will be understood to refer herein to any device for providing wireless connectivity including, but not limited to, access points, access networks, base station routers, and the like. The base station 105 includes one or more antennas 115 that are configured to transmit radiofrequency signals generated by the base station 105 and/or receive radiofrequency signals generated by other sources.

Mobile units 120 may access the wireless communication system 100 by establishing a wireless communication link 125 at the base station 105. The wireless communication link 125 may include one or more uplink channels 130 for transmitting information from the mobile unit 120 to the base station 105 and one or more downlink channels 135 for transmitting information from the base station 105 to the mobile unit 120. The wireless communication link 125, the uplink channels 130, and the downlink channels 135 may be established according to any wireless communication protocol. Exemplary wireless communication protocols include, but are not limited to, Time Division Multiple Access (TDMA), Frequency Division Multiple Access (FDMA), Code Division Multiple Access (CDMA), and Orthogonal Frequency Division Multiple Access (OFDMA), as well as the standards and/or protocols defined by the Third Generation Partnership Project (3GPP, 3GP2), the Institute of Electrical and Electronics Engineers (IEEE), and/or other organizations. Techniques for establishing and/or operating the wireless communication link 125, the uplink channels 130, and the downlink channels 135 are known in the art and in the interest of clarity only those aspects of establishing and/or operating the wireless communication link 125, the uplink channels 130, and the downlink channels 135 that are relevant to the present invention will be discussed herein.

An integrated test system 145 is coupled to the base station 105. In one embodiment, the integrated test system 145 is a separate physical entity that may be coupled to an existing base station 105. For example, the integrated test system 145 may be coupled to the base station 105 using one or more dedicated ports (not shown) in the base station 105. Alternatively, the integrated test system 145 may not be separate and distinct from the base station 145 and instead may include digital circuitry that is integrated within the body of the base station 105. Persons of ordinary skill in the art having benefit of the present disclosure should appreciate that the integrated test system 145 may be implemented in hardware, firmware, software, or any combination thereof. The integrated test system 145 is capable of communicating with the processing device 150 that is deployed remote from the base station 105. The dashed box surrounding the processing device 150 is intended to indicate that the processing device 150 is deployed at a location that is remote from the base station 105 shown in FIG. 1. The actual distance between the base station 105 and the processing device 150 is a matter of design choice.

Communication between the integrated test system 145 and the processing device 150 may take place while the integrated test system 145 is coupled to the base station 105. For example, the integrated test system 145 may include one or more system interfaces that support communication between the integrated test system 145 and the processing device 150 over various wired and/or wireless communication links. The configuration of the wired and/or wireless communication links that are used to support communication between the integrated test system 145 and the processing device 150 is a matter of design choice. Persons of ordinary skill in the art having benefit of the present disclosure should be able to design and implement the wired and/or wireless communication links between the integrated test system 145 and the processing device 150 according to known principles of communication.

In operation, the integrated test system 145 may tap into portions of the signals received by the base station 105. For example, the integrated test system 145 may access portions of the signals transmitted to the mobile unit 120 by the base station 105 via the antennas 115 and over the downlink 135 of the wireless communication link 125. For another example, the integrated test system 145 may access portions of the signals transmitted by the mobile unit 120 over the uplink 130 of the wireless communication link 125 and received by the base station 105 via the antennas 115. The integrated test system 145 may then perform one or more measurements on the accessed radiofrequency signals. The results of these measurements may be stored in the integrated test system 145 and/or transmitted to the processing device 150 for further processing. Transmission of the measurement results to the processing device 150 may take place while the integrated test system 145 is coupled to the base station 105.

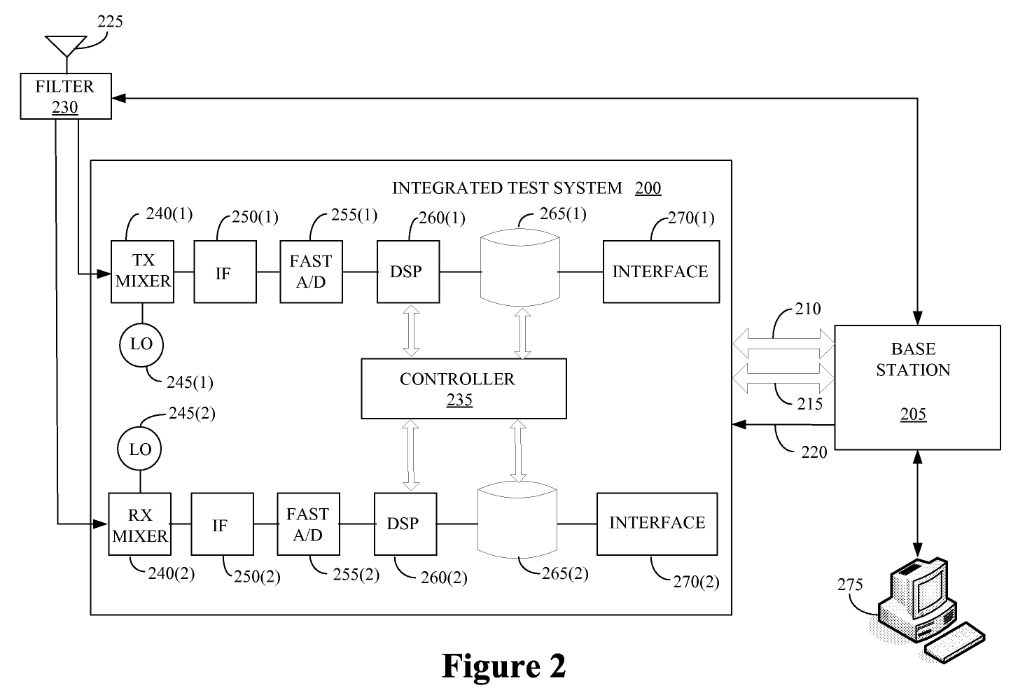

FIG. 2 conceptually illustrates one exemplary embodiment of an integrated test system 200. In the illustrated embodiment, the integrated test system 200 is coupled to a base station 205. As discussed above, the integrated test system 200 may be either a separate entity that is coupled to the base station 205 (e.g., using ports in the base station 205) or digital circuitry that is integrated into the base station 205. The integrated test system 200 can therefore exchange control information (as indicated by the arrow 210) and/or data (as indicated by the arrow 215) with the base station 205. For example, the integrated test system 200 may exchange control information and/or data via ports in the base station 205 or other connections, such as a wired connection. The base station 205 may also provide (as indicated by the arrow 220) a timing reference signal that may be used by the integrated test system 200. The timing reference signal may be formed based on a system clock maintained in the base station 205.

The base station 205 is coupled to an antenna 225 via filter 230, such as a transmit/receive filter 230. The base station 205 may therefore transmit and receive modulated radiofrequency signals using the antenna 225 and the filter 230. The filter 230 may also provide portions of the transmitted and/or received radiofrequency signals to the integrated test system 200. For example, the filter 230 may include a splitter that redirects portions of the transmitted and/or received radiofrequency signals to the integrated test system 200. However, persons of ordinary skill in the art having benefit of the present disclosure should appreciate that the present invention is not limited to any particular kind of filter 230. Nor is the present invention limited to a design in which the base station 205 is directly coupled to the filter 230, which then provides the signals to the integrated test system 200. In alternative embodiments, portions of the integrated system 200 may be deployed along the signal path between the base station 205 and the filter 230 and/or antenna 225.

The integrated test system 200 includes a controller 235 for controlling operation of the integrated test system 200. In various alternative embodiments, the controller 235 may be implemented in hardware, firmware, software, or any combination thereof. In the illustrated embodiment, the integrated test system 200 includes separate pathways for processing transmitted radiofrequency signals (i.e., downlink signals) and received radiofrequency signals (i.e., uplink signals). Similar entities along the two pathways will be indicated by a common numeral and a distinguishing index (1) for the transmit path and (2) for the receive path. Persons of ordinary skill in the art having benefit of the present disclosure should appreciate that the entities along the transmit path and the receive path may be implemented as separate devices or as a single multi-purpose device. For example, transmit mixer 240(1) and receive mixer 240(2) may be implemented as separate mixers or as a single mixer that may be used in both the transmit path and the receive path.

The transmit path receives a portion of the transmitted radiofrequency signal from the filter 230 at the transmission signal mixer 240(1). The transmission signal mixer 240(1) may mix the portion of the transmitted radiofrequency signal with a signal from a low-frequency oscillator 245(1) to generate a signal that corresponds to a selected portion of the transmitted radiofrequency signal having a particular frequency or within a particular frequency band. For example, the low-frequency oscillator 245(1) may be used to tune the integrated test system 200 to uplink and/or downlink cellular and/or PCS frequencies. The selected portion of the transmitted radiofrequency signal may then be passed to an intermediate frequency transform stage 250(1) and a fast analog-to-digital converter 255(1) to convert the selected portion of the transmitted radiofrequency signal into a digital representation of the selected portion.

A digital signal processor 260(1) may perform one or more measurements or operations on the digital representation of the selected portion of the transmitted radiofrequency signal. The measurements may be formed based on instructions and/or parameters provided by the controller 235. Exemplary measurements include, but are not limited to, spectral analysis, code domain measurements, measurements of radiofrequency powers associated with transmitted or received signals, interference or noise measurements, and the like. Results of the measurements or operations may be stored in a data storage unit 265(1). For example, the integrated test system 200 may include internal random access memory (RAM) that may be used to store the results of the measurements and/or operations carried out by the entities in the transmit path. The receive path operates in an analogous manner to generate and store measurements performed on a portion of the received radiofrequency signal provided by the filter 230.

The transmit path and the receive path also include interfaces 270(1-2) that are used to support communication between the integrated test system 200 and one or more external processing devices 275. Exemplary interfaces include interfaces that operate according to the RS-232 protocol and IP-based interfaces such as the interfaces used for high-speed Ethernet connections. In the illustrated embodiment, the processing device 275 is deployed at a location that is remote from the base station 205. The interfaces 270(1-2) may support communication of information, such as the result of the measurements performed by the integrated test system 200, between the integrated test system 200 and the remote processing device 275. These communications may take place while the integrated test system 200 remains coupled to the base station 205. Although only a single processing device 275 is depicted in FIG. 2, persons of ordinary skill in the art having benefit of the present disclosure should appreciate that any number of processing devices 275 may communicate with the integrated test system 200.

In one embodiment, the processing device 275 may be used to request and/or modify one or more measurements performed by the integrated test system 200. For example, an engineer may select one or more measurements, or one or more parameters that should be used for a measurement, using the processing device 275. The selected measurements and/or parameters may then be communicated to the controller 235 in the integrated test system 200 via one or more of the interfaces 270(1-2). The controller 235 may then use the selected measurements and/or parameters to control elements in the transmit path and/or the receive path to perform the desired measurements. For example, an engineer may request a measurement of the transmission power associated with a frequency band, a time period, and/or a channel code. For another example, an engineer may request a single measurement at a selected time or may request continuous and/or periodic measurements.

The processing device 275 can display results of the measurements performed by the integrated test system 200 and perform post-processing of these measurements. For example, an engineer may have requested periodic measurements of the transmission power used by the base station 205. As these measurements arrive at the processing device 275, they may be displayed, e.g., as a plot of the transmission power as a function of time. In one embodiment, the processing device 275 may use the data to verify the transmission power calibration of the base station 205. If the transmission power calibration deviates from an expected value by more than a permitted tolerance, then the processing device 275 may issue an alarm. The processing device 275 may also use the periodic measurements of the transmission power to measure fluctuations in the transmission power over time. For example, the processing device 275 may determine a mean value of the transmission power and a standard deviation representing the magnitude of the fluctuations about this mean value. If the amplitude of the fluctuations exceeds a permitted tolerance, then the processing device 275 may issue an alarm.

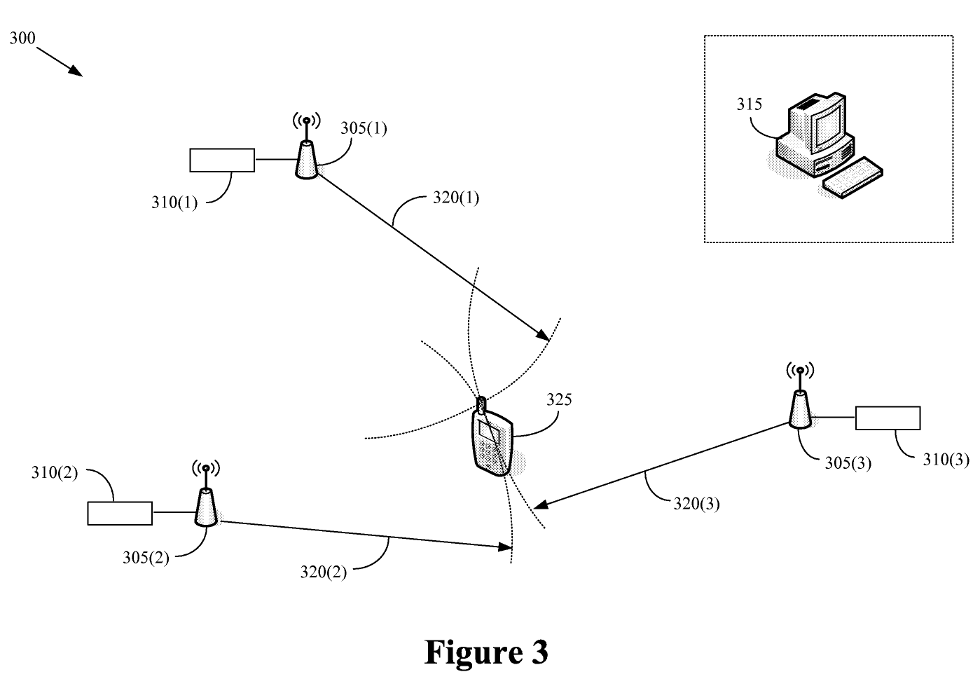

FIG. 3 conceptually illustrates a second exemplary embodiment of a wireless communication system 300. In the illustrated embodiment, the wireless communication system 300 includes multiple base stations 305(1-3) that include integrated test systems 310(1-3). As discussed herein, the integrated test systems 310(1-3) are capable of performing measurements and communicating information indicative of these measurements to a remotely located processing device 315 while remaining coupled to the corresponding base station 305(1-3). In one embodiment, the information that is communicated to the processing device 315 includes a Global Positioning System (GPS) timestamp that indicates the location of the base station 305(1-3) that performed the measurement and the time at which the measurement was performed.

The processing device 315 may combine information provided by the base stations 305(1-3) to characterize aspects of the wireless communication system 300. In the illustrated embodiment, the processing device 315 may request measurements, such as transmitted and/or received power measurements, which may be used to determine distances 320(1-3) between the base stations 305(1-3) and a source of radiofrequency transmissions, such as a mobile unit 325. For example, measurements of radiofrequency transmissions on the uplink and downlink between the mobile unit 325 and the base stations 305(1-3) may be used to determine the distances 320(1-3). This information may be communicated to the processing device 315, along with the associated GPS timestamps, and this information may be used to triangulate the location of the mobile unit 325. Thus, the information from multiple base stations 305(1-3) may be used to locate mobile units 325.

In one embodiment, the mobile unit 325 (or some other source of radiofrequency signals and/or noise) may be a source of interference in the wireless communication system 300. The processing device 315 may be used to request measurements, such as the power and/or spectrum of received signals in a selected bandwidth, which may be used to characterize the source of interference. For example, as discussed above, measurements performed by the base station 305(1-3) may be used to determine a location of the source of interference. Furthermore, measurements such as the spectrum of the received signals may be used to determine a signature of the interference source. Although the example above discusses using coordinated measurements by multiple base stations 305(1-3) to locate a source of radiofrequency transmission, persons of ordinary skill in the art having benefit of the present disclosure should appreciate that this example is intended to be illustrative and not to limit the present invention. In alternative embodiments, various types of coordinated measurements are multiple base stations 305(1-3) may be used for other purposes.

Embodiments of the techniques described herein may have a number of advantages over conventional practice. For example, the remote measurement and/or troubleshooting capabilities described herein may permit wireless service providers to remotely access base station radiofrequency performance measurements that otherwise would require a site visit by an engineer. The techniques described herein may also enhance the diagnostic capability of the base station to provide more exhaustive system coverage. Furthermore, cell site test set measurements can be remotely collected on-demand and data from multiple base station sites can be cross correlated by the wireless service provider. Embodiments of the base stations and integrated test system described herein may also benefit from an enhanced alarm capability that may aid in detection and troubleshooting of transmit path and/or receiver path malfunctions and/or degraded performance. The techniques described herein also permit on-demand uplink interference measurement and/or analysis using data collected at remote locations, as well as detection and/or localization (GPS Time Stamped) of the mobile units and sources of noise and interference. Calibration of the radiofrequency transmission and/or reception paths, as well as verification of the calibration, may also be performed remotely and on-demand. The integrated test system may also permit enhanced antenna test functionality that may be used to verify connectivity and performance of base station antennae. Furthermore, the diagnostic and functional test capability of the base station may be enhanced by embodiments of the integrated test system.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method, comprising:
accessing, using digital processing circuitry coupled to at least one base station, a portion of a radio frequency signal;
performing, using the digital processing circuitry, at least one measurement based upon the radiofrequency signal; and
providing information indicative of said at least one measurement to a processing device at a location remote from the base station while the digital processing circuitry remains coupled to said at least one base station.

2. The method of claim 1, wherein accessing the portion of the radio frequency signal comprises accessing a portion of at least one of an uplink signal and a downlink signal provided by a filter associated with said at least one base station.

3. The method of claim 1, comprising accessing at least one of control information, data, and a timing reference signal, and wherein performing said at least one measurement comprises performing said at least one measurement based upon said at least one of the control information, the data, and the timing reference signal.

4. The method of claim 1, comprising accessing information indicative of at least one requested measurement, the information indicative of said at least one requested measurement being provided by the processing device, and wherein performing said at least one measurement comprises performing said at least one requested measurement.

5. The method of claim 1, wherein performing said at least one measurement comprises performing at least one of a spectral analysis, a code domain measurement, a radiofrequency power measurement, and an interference measurement.

6. The method of claim 5, wherein performing said at least one radiofrequency power measurement comprises performing at least one radiofrequency power measurement for calibrating a transmission power of said at least one base station.

7. The method of claim 1, wherein accessing the portion of the radio frequency signal comprises accessing, using a plurality of digital circuits coupled to a corresponding plurality of the base stations, a plurality of portions of radiofrequency signals associated with the plurality of base stations.

8. The method of claim 7, wherein performing said at least one measurement comprises performing a plurality of measurements based on uplink or downlink radiofrequency signals associated with the plurality of base stations.

9. The method of claim 8, comprising providing information indicative of the plurality of measurements to the processing device remote from the plurality of base stations while the corresponding digital circuit remains coupled to the corresponding base station.

10. A method, comprising:
receiving, at a processing device deployed remote from at least one base station, information indicative of at least one measurement performed using digital processing circuitry coupled to said at least one base station, said at least one measurement being performed on a portion of a radiofrequency signal, and the information being received while the digital processing circuitry remains coupled to said at least one base station.

11. The method of claim 10, comprising providing, from the processing device, information indicative of at least one requested measurement.

12. The method of claim 11, comprising processing, at the processing device, the information indicative of said at least one measurement.

13. The method of claim 12, wherein receiving information indicative of said at least one measurement comprises receiving information indicative of at least one of a spectral analysis, a code domain measurement, a radiofrequency power measurement, and an interference measurement.

14. The method of claim 13, wherein processing the information indicative of said at least one measurement comprises calibrating a transmission power of said at least one base station based on the received information indicative of the radiofrequency power measurement.

15. The method of claim 12, wherein receiving information indicative of said at least one measurement comprises receiving information indicative of a plurality of measurements, each of the plurality of measurements being performed by digital circuitry at one of a plurality of base stations, each of the plurality of measurements being based on a portion of a radiofrequency signal associated with said one of the plurality of base stations.

16. The method of claim 15, wherein receiving information indicative of the plurality of measurements comprises receiving information indicative of the plurality of measurements while the corresponding digital circuitry remains coupled to the corresponding base station.

17. The method of claim 15, wherein processing information indicative of the plurality of measurements comprises determining at least one of a location and a signature of at least one source of interference based on the received information indicative of the plurality of measurements.
